(19) United States
(12) Patent Application Publication
(10) Pub. No.: US 2026/0136062 A1
(43) Pub. Date: May 14, 2026

(54) ADAPTIVE BRIGHTNESS AND CONTRAST ENHANCEMENT FOR FINAL VIEW FRAMES

(71) Applicant: Samsung Electronics Co., Ltd., Suwon-si (KR)

(72) Inventor: Yingen Xiong, Mountain View, CA (US)

(21) Appl. No.: 19/219,803

(22) Filed: May 27, 2025

Related U.S. Application Data
(60) Provisional application No. 63/720,523, filed on Nov. 14, 2024.

(51) Int. Cl. H04N 21/431; G06T 5/92; G06T 5/94; G06T 7/90

(52) U.S. Cl. CPC H04N 21/431; G06T 5/92; G06T 5/94; G06T 7/90; G06T 2207/20072

(57) ABSTRACT

A method includes obtaining, using at least one imaging sensor of an electronic device, a color image frame of a scene. The method also includes applying, using at least one processing device of the electronic device, at least one passthrough transformation to the color image frame in order to generate a transformed image frame. The method further includes determining, using the at least one processing device, that a visual quality of the transformed image frame falls outside of a visual quality criterion including a brightness criterion and a contrast criterion. In addition, the method includes, in response to determining that the visual quality of the transformed image frame falls outside of the visual quality criterion, performing, using the at least one processing device, visual quality enhancement to the transformed image frame in order to generate a final image frame for rendering.

### CROSS-REFERENCE TO RELATED APPLICATION AND PRIORITY CLAIM

This application claims priority under 35 U.S.C. § 119(e) to U.S. Provisional Patent Application No. 63/720,523 filed on Nov. 14, 2024. This provisional patent application is hereby incorporated by reference in its entirety.

### TECHNICAL FIELD

This disclosure relates generally to image processing systems and processes. More specifically, this disclosure relates to adaptive brightness and contrast enhancement for final view frames.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive brightness and contrast enhancement for final view frames.

In a first embodiment, a method includes obtaining, using at least one imaging sensor of an electronic device, a color image frame of a scene. The method also includes applying, using at least one processing device of the electronic device, at least one passthrough transformation to the color image frame in order to generate a transformed image frame. The method further includes determining, using the at least one processing device, that a visual quality of the transformed image frame falls outside of a visual quality criterion including a brightness criterion and a contrast criterion. In addition, the method includes, in response to determining that the visual quality of the transformed image frame falls outside of the visual quality criterion, performing, using the at least one processing device, visual quality enhancement to the transformed image frame in order to generate a final image frame for rendering.

In a second embodiment, an apparatus includes at least one imaging sensor and at least one processing device configured to obtain a color image frame of a scene using the at least one imaging sensor. The at least one processing device is also configured to apply at least one passthrough transformation to the color image frame in order to generate a transformed image frame. The at least one processing device is further configured to determine that a visual quality of the transformed image frame falls outside of a visual quality criterion including a brightness criterion and a contrast criterion. In addition, the at least one processing device is configured, in response to the determination that the visual quality of the transformed image frame falls outside of the visual quality criterion, to perform visual quality enhancement to the transformed image frame in order to generate a final image frame for rendering.

In a third embodiment, a non-transitory machine readable medium contains instructions that when executed cause at least one processor of an electronic device to obtain a color image frame of a scene using at least one imaging sensor. The non-transitory machine readable medium also contains instructions that when executed cause the at least one processor to apply at least one passthrough transformation to the color image frame in order to generate a transformed image frame. The non-transitory machine readable medium further contains instructions that when executed cause the at least one processing device to determine that a visual quality of the transformed image frame falls outside of a visual quality criterion including a brightness criterion and a contrast criterion. In addition, the non-transitory machine readable medium contains instructions that when executed cause the at least one processor, in response to the determination that the visual quality of the transformed image frame falls outside of the visual quality criterion, to perform visual quality enhancement to the transformed image frame in order to generate a final image frame for rendering.

Any one or any combination of the following features may be used with the first, second and third embodiment. Whether the visual quality of the transformed image frame falls outside of the visual quality criterion may be determined by converting a color format of the transformed image frame; extracting a luminance component from the converted color format of the transformed image frame; determining brightness and contrast of the transformed image frame using the luminance component; creating the brightness criterion and the contrast criterion based on the brightness and contrast of the transformed image frame and specified brightness and contrast thresholds; and determining that the transformed image frame has brightness falling outside of the brightness criterion and/or contrast falling outside of the contrast criterion. The determined brightness can be a mean value of the luminance component. The determined contrast can be a standard deviation value of the luminance component. The visual quality enhancement to the transformed image frame may be performed by applying a local visual enhancement to one or more portions of the transformed image frame and by applying a global visual enhancement to the transformed image frame. The one or more portions have the visual quality outside of the visual quality threshold. The local visual enhancement may be applied by identifying the one or more portions of the transformed image frame having the visual quality falling outside of the visual quality criterion; identifying one or more visual enhancement algorithms for the one or more portions of the transformed image; determining enhanced brightness and enhanced contrast for the one or more portions of the transformed image using the one or more visual enhancement algorithms; and verifying the enhanced brightness and the enhanced contrast using a histogram of the transformed image frame and one or more specified thresholds. The global visual enhancement may be applied to the transformed image frame by identifying one or more visual enhancement algorithms for the transformed image frame; determining enhanced brightness and enhanced contrast for the transformed image frame using the one or more visual enhancement algorithms; and verifying the enhanced brightness and the enhanced contrast using a histogram of the transformed image frame and one or more specified thresholds. The one or more visual enhancement algorithms may include one or more brightness enhancement algorithms and one or more contrast enhancement algorithms. The color image frame may be one of a sequence of color image frames, the passthrough transformation may be applied to each color image frame of the sequence to generate a corresponding sequence of transformed image frames, and the visual quality enhancement may be performed by balancing brightness enhancement and contrast enhancement of each transformed image frame to provide consistency in the brightness enhancements and contrast enhancements throughout the sequence of transformed image frames. The final image frame may be rendered for display.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for adaptive brightness and contrast enhancement for final view frames in accordance with this disclosure;

FIGS. 3A-3C illustrate example functions of the process of FIG. 2 in accordance with this disclosure;

FIG. 4 illustrates an example visual enhancement technique in accordance with this disclosure;

FIG. 5 illustrates an example brightness enhancement technique in accordance with this disclosure;

FIG. 6 illustrates an example contrast enhancement technique in accordance with this disclosure;

FIGS. 7A-7B illustrate example results obtainable using adaptive brightness and contrast enhancement in accordance with this disclosure; and

FIG. 8 illustrates an example method for adaptive brightness and contrast enhancement in accordance with this disclosure.

### DETAILED DESCRIPTION

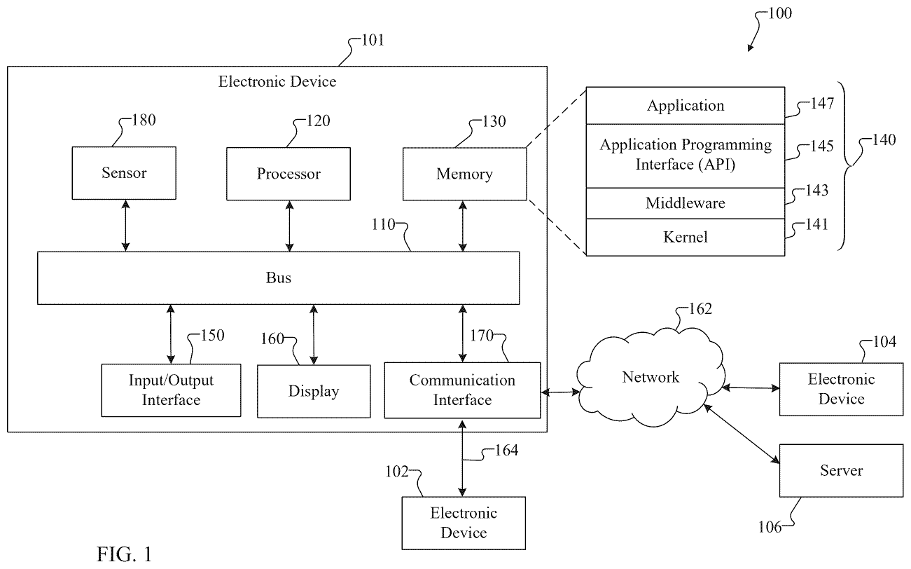

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be affected by conditions in the surrounding environment and properties of the imaging sensors themselves. For example, when inadequate lighting is available in the user's surrounding environment, captured image frames can appear dark. Too high or too low brightness and/or contrast of the frames can make it difficult for the user to perceive the contents of the frames and even cause user discomfort.

This disclosure provides various techniques supporting adaptive brightness and contrast enhancement for final view frames for XR or other applications. As described in more detail below, one or more color image frames of a scene can be obtained using at least one image sensor of an electronic device. Each captured image frame can undergo a passthrough transformation using at least one processing device of the electronic device. The brightness and/or contrast of the transformed image frame can be determined to be outside of respective criteria. In response to the determination that the brightness and/or contrast of the transformed image frame is outside of the respective criteria, a visual quality enhancement can be made to the transformed image frame to generate a final image frame for rendering. The visual enhancement can include adaptively adjusting brightness and/or contrast of the transformed image frame. For a sequence of colored image frames, the visual quality enhancement can include providing a consistency in the adaptively-adjusted brightness and/or contrast, such as to help ensure that there is no sudden rise or fall in the adjusted brightness and/or contrast.

In this way, the disclosed techniques can be used to provide visual enhancement of colored image frames, including image frames captured indoors or outdoors in abnormal (such as low-light or high-light) environments. For example, the disclosed techniques can enable improved images to be rendered and displayed to users, even when those images are based on image frames that are captured in low-light or high-light conditions. As a result, this can significantly improve user experience, even in abnormal-light environments. Moreover, these techniques can be used to improve abnormal-light image quality and enhance image visibility, which can lead to the generation of normal-quality image frames captured in abnormal-light environments. As a result, more-comfortable final view frames can be provided to the user to view his or her surroundings. This type of functionality may find use in various applications, such as abnormal-light image visibility enhancement for XR devices or other devices, and abnormal-light image quality enhancement for XR devices or other devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive brightness and contrast enhancement for final view frames in XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform adaptive brightness and contrast enhancement for final view frames in XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive brightness and contrast enhancement for final view frames in XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

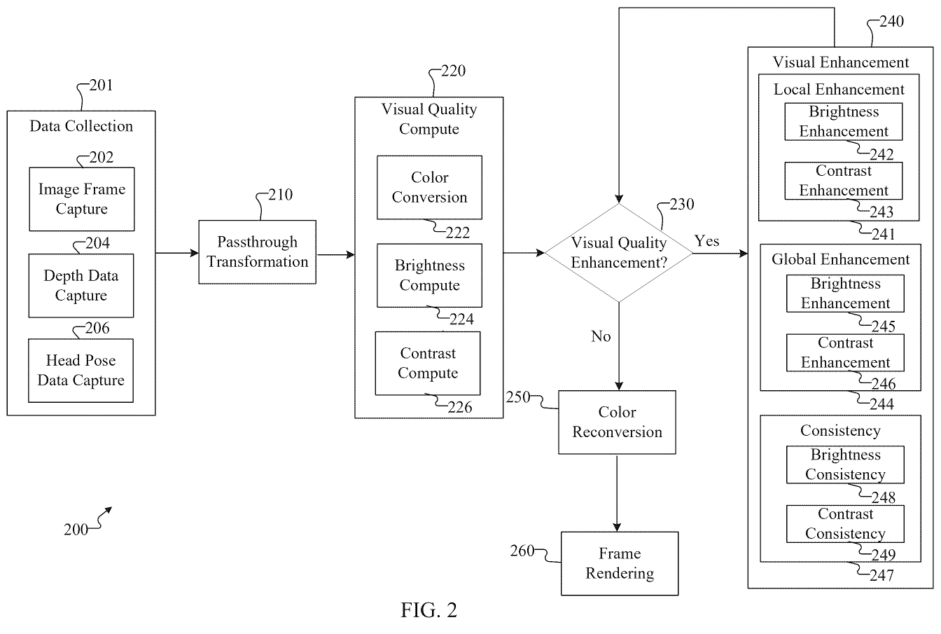

FIG. 2 illustrates an example process 200 for adaptive brightness and contrast enhancement for final view frames in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes a data collection operation 201, a passthrough transformation operation 210, a visual quality compute operation 220, a determination operation 230, a visual enhancement operation 240, a color reconversion operation 250, and a frame rendering operation 260. The data collection operation 201 generally operates to obtain one or more image frames of a scene and associated data. In this example, the data collection operation 201 includes an image frame capture operation 202, a depth data capture operation 204, and a head pose data capture operation 206. The image frame capture operation 202 generally operates to capture one or more image frames of a scene. In some cases, each image frame may be a high-resolution color image frame, such as one captured by the electronic device 101 using one or more imaging sensors 180 of the electronic device 101. Also, in some cases, each captured image frame may represent an image frame of a scene captured by a forward-facing or other imaging sensor(s) 180 of the electronic device 101.

The depth data capture operation 204 generally operates to obtain depth data associated with each image frame. The depth data may be obtained from any suitable source(s), such as from one or more depth sensors like at least one time-of-flight (ToF) sensor, light detection and ranging (LiDAR) sensor, or stereo vision sensor. In some cases, for example, the depth data may include time measurements of light pulses returning to a ToF sensor, distorted light patterns, or RGB images from slightly different angles.

The head pose data capture operation 206 generally operates to obtain information related to the pose of a user's head while the electronic device 101 is being used. The head pose information may be obtained from any suitable source(s), such as from one or more positional sensors like at least one IMU, head pose tracking camera, or other position sensor(s) 180 of the electronic device 101. In some cases, the head pose information may be expressed using six degrees of freedom, such as three translation values and three rotation values. The three translation values may identify the movement of the user's head along three orthogonal axes, and the three rotation values may identify rotation of the user's head about the three orthogonal axes. Note, however, that the head pose information may have any other suitable form.

The passthrough transformation operation 210 generally operates to apply one or more transformations to the one or more image frames in order to generate one or more transformed image frames. The transformations can be static or dynamic depending on the implementation. In some cases, static transformations may include camera undistortion, display correction, and viewpoint matching. Camera undistortion may include the processor 120 of the electronic device 101 undistorting the captured image frames using respective intrinsic parameters of the imaging sensor(s) 180 used to capture the image frames. The intrinsic parameters generally describe how each imaging sensor 180 perceives objects and can include a focal length, a principal point, and distortion coefficients. The focal length may indicate the degree of the imaging sensor's telescopic strength (such as an amount of zooming). The principal point may indicate the center of the image on which the imaging sensor's optical points are focused. The distortion coefficients may indicate an extent of lens distortions (such as image warping caused by a lens of the imaging sensor). Since the processor 120 can learn the intrinsic parameters for each imaging sensor 180, the processor 120 can identify the extent of the lens distortions and correct for the associated image distortions, such as by moving pixels so that straight lines appear straight.

Display correction may include the processor 120 correcting display lens distortions and chromatic aberrations. The display lens correction and the chromatic aberration correction can be used to compensate for distortions created in displayed images, such as geometric distortions and chromatic aberrations created by display lenses (which are lenses positioned between the user's eyes and one or more display panels forming the display(s) 160). Viewpoint matching may include the processor 120 applying transformations to compensate for things like registration and parallax errors, which may be caused by factors like differences between the positions of the imaging sensor(s) 180 and the user's eyes. That is, captured image frames are captured by one or more imaging sensor(s) 180 at one or more locations, but rendered images are viewed by the user's eyes that are at different locations.

In some cases, the passthrough transformation operation 210 may apply a rotation and/or a translation to each image frame in order to compensate for these or other types of issues. Ideally, the transformations give the appearance that the images presented to the user are captured at the locations of the user's eyes, when the image frames in reality are captured at one or more different locations. Often times, the rotation and/or translation can be derived mathematically based on the position and angle of each imaging sensor 180 and the expected or actual positions of the user's eyes.

In some cases, dynamic transformations may include head pose change compensation. This may include the processor 120 applying a transformation to reproject each of the transformed image frames generated by the passthrough transformation operation 210 based on an expected head pose of the user (if necessary). For example, the processor 120 may obtain inputs from an IMU, a head pose tracking camera, or other position sensor(s) 180 of the electronic device 101 while image frames are being captured using the one or more imaging sensors 180. The processor 120 can use this information to estimate what the user's head pose will likely be when rendered images are actually displayed to the user. In many cases, for instance, image frames will be captured at one time and rendered images will be subsequently displayed to the user some amount of time later, and it is possible for the user to move his or her head during this intervening time period. The head pose change compensation can therefore be used to estimate, for each image frame, what the user's head pose will likely be when a rendered image based on that image frame will be displayed to the user. The head pose change compensation can also apply a translation, rotation, and/or other transformation to each transformed image frame, which can result in the generation of additional transformed image frames.

The visual quality compute operation 220 generally operates to determine the visual quality of the one or more transformed image frames. In this example, the visual quality compute operation 220 includes a color conversion operation 222, a brightness compute operation 224, and a contrast compute operation 226. The color conversion operation 222 generally operates to convert the transformed image frames, such as from an RGB format to a YUV or YCbCr format or to an HSV format. This conversion may be used to separate a luminance channel (Y or V) of each transformed image frame from one or more color channels of the transformed image frame. That is, a color image can be made of pixels, and each pixel can have an associated color. A color format describes how the processor 120 can describe the pixel color using numbers. The electronic device 101 may take image frames in the RGB format, where each pixel has three numbers describing the amounts of red (R), green (G), and blue (B) mixed within the pixel. In the RGB format, however, brightness and color are blended, making it difficult to adjust only the brightness without changing the colors. Converting the RGB format into the YUV, YCbCr, HSV, or other format can separate the luminance (brightness information) from the chrominance (color information), thereby making it easier to adjust the brightness without altering the colors.

In some embodiments, the color format of a color image can be converted from the RGB format to the HSV format, and this conversion may be represented in the following manner.

$$I ( H , S , V ) ← I ( R , G , B ) \qquad ( 1 )$$

Here, (R, G, B) are the red, green, and blue channels of the color image I(R, G, B), and (H, S, V) are the hue, saturation, and value channels of the color image I(H, S, V). In this example, V is the luminance channel of the color image I(H, S, V). However, a color image I(R, G, B) can be converted to other formats, such as YUV or YCbCr format, to obtain the luminance channel, and this conversion may be represented in the following manner.

$$I ( Y , U , V ) ← I ( R , G , B ) \qquad ( 2 )$$

$$or$$

$$I ( Y , Cb , Cr ) ← I ( R , G , B ) \qquad ( 3 )$$

In these examples, the Y channel is the luminance channel. The luminance channel image I(luminance) can therefore be extracted from the color-converted image frame.

While brightness and contrast enhancement can be processed in the V channel of the HSV color format, the brightness and contrast enhancement can be performed for all color channels. For example, the brightness and contrast enhancement for R, G, B channels can be performed separately to obtain an enhanced image. Further, while the brightness and contrast enhancement can be processed separately in the V channel of the HSV color format, the brightness and contrast enhancement can be performed simultaneously for the luminance component. In this way, the brightness and contrast can be made consistent during the brightness and contrast enhancement.

The brightness compute operation 224 generally operates to determine the brightness within the luminance component (the luminance channel) of each transformed image frame and identify a brightness criterion for each transformed image frame. In some embodiments, this may include the processor 120 determining the mean value μ and the standard deviation σ of the luminance channel image I(luminance), which can be expressed as follows.

$$\{ \begin{matrix}μ = \frac{1}{MN} {\sum }_{i = 0}^{N - 1} {\sum }_{j = 0}^{M - 1} I ( i , j ) \\ σ = \sqrt{\frac{1}{MN} {\sum }_{i = 0}^{N - 1} {\sum }_{j = 0}^{M - 1} {( I ( i , j ) - μ )}^{2}}\end{matrix} \qquad ( 4 )$$

Here, I(i, j) is the luminance component of the color image, M is the width of the image, and N is the height of the image. The processor 120 may also determine the histogram of the luminance channel image I(luminance) for image contrast analysis and enhancement, which can be expressed as follows.

$${H}_{hist} = h ( I ( luminance ) , {N}_{bin} ) \qquad ( 5 )$$

Here, I(luminance) is the luminance component of the color image, and N_{bin} is the number of the bins in building the image histogram. In addition, the processor 120 may identify the value μ of the luminance image as a brightness measurement B of the current transformed image, which can be expressed as follows.

$$B ( I ( luminance ) ) = μ \qquad ( 6 )$$

With the brightness measurement from Equation (6), the brightness compute operation 224 can create a brightness criterion BC to determine if the brightness B of the current transformed image frame is sufficient. In some cases, the brightness criterion BC may be an acceptable range of brightness (such as 95<BC<100) for the current transformed image, given the current lightness environment. Also, in some cases, the brightness criterion BC can be created based on one or more predetermined thresholds, which could be set by the manufacturer of the electronic device 101.

The contrast compute operation 226 generally operates to determine the contrast of a current transformed image frame and identify a contrast criterion CC for each transformed image frame. Contrast refers to the difference between the darkest and brightest parts in an image, such as a degree of difficulty in distinguishing a dark table from a bright ceiling. In some cases, contrast C of the luminance channel image I(luminance) can be computed by using the standard deviation σ of the luminance image, which can be expressed as follows.

$$C ( I ( luminance ) ) = σ \qquad ( 7 )$$

With the contrast measurement from Equation (7) and the histogram computed from Equation (5), the contrast criterion CC can be computed to determine if the contrast of the current transformed image frame is sufficient. In some cases, the contrast criterion CC can be an acceptable range of contrast (such as 50<CC<65) for the current transformed image, given the current lightness environment. Also, in some cases, the contrast criterion CC can be created based on one or more predetermined thresholds, which could be set by the manufacturer of the electronic device 101.

In some embodiments, the compute operations 224 and 226 may be implemented using one or more GPUs with shaders. Since GPUs can perform parallel computing tasks, the implementation on the GPUs can increase the efficiency and speed of the compute operations 224 and 226.

The determination operation 230 generally operates to determine whether the visual quality including the brightness B and contrast C of the current transformed image frame is sufficient. This may include the processor 120 checking the brightness criterion BC with the brightness thresholds and requirements. Note that different brightness thresholds can be set for different lightness environments, such as during manufacturer calibration for the electronic device 101. Thus, the processor 120 can identify a brightness threshold for a same or substantially similar lightness environment and determine whether the brightness criterion BC is consistent with the corresponding brightness threshold (such as whether the brightness criterion BC includes the threshold). For example, if the computed brightness criterion is 95<BC<105 and the corresponding threshold is 100, the current transformed image frame having the computed brightness B=101 can be determined to have a sufficient brightness. If the computed brightness is outside of the BC criterion, the determination operation 230 can determine that the brightness enhancement is to be performed on the current transformed image frame.

The processor 120 can also determine whether the current transformed image frame has a sufficient contrast C. Again, different contrast thresholds can be set for different lightness environments, such as during manufacturer calibration for the electronic device 101. Thus, the processor 120 can identify a contrast threshold for a same or substantially similar lightness environment and determine whether the contrast criterion CC is consistent with the corresponding contrast threshold (such as whether the contrast criterion CC includes the threshold). For example, if the computed contrast criterion CC is 60<CC<80 and the corresponding threshold is 70, the current transformed image frame having the computed contrast C=40 is determined to have an insufficient contrast, and the determination operation 230 can determine that contrast enhancement is to be performed on the current transformed image frame.

In some embodiments, a combined criterion can be created, such as by integrating the criterions of the brightness measurement, contrast measurement, and histogram, to measure the image visual quality. With the combined criterion, it can be determined if the current transformed image frame needs to be enhanced in brightness and contrast. This combined criterion can be also used after the brightness and contrast enhancement, such as for a final check of the visual quality of the transformed image frame.

The visual enhancement operation 240 generally operates to enhance the visual quality of the transformed image frame. In this example, the visual enhancement operation 240 includes a local visual enhancement operation 241, a global visual enhancement operation 244, and a consistency operation 247. In some embodiments, the local and global visual enhancement operations 241, 244 may be performed simultaneously for each of the transformed image frames to reduce computation requirement and increase efficiency.

The local visual enhancement operation 241 generally operates to enhance the visual quality of one or more portions of a transformed image frame. In this example, the local visual enhancement operation 241 includes a local brightness enhancement operation 242 and a local contrast enhancement operation 243. The local brightness enhancement operation 242 generally operates to enhance the brightness of one or more portions of the transformed image frame. This may include the processor 120 identifying each portion of the transformed image frame having a brightness outside of the brightness criterion and adjusting the brightness of that portion to satisfy the brightness criterion. For example, if the processor 120 identifies a desk portion having a brightness lower than a minimum brightness criterion, it may adjust (raise) the brightness of the desk portion until the brightness criterion is satisfied. In some cases, the processor 120 may perform local brightness enhancement in a loop until the brightness criterion is satisfied. Upon completion of the local brightness enhancement, the transformed image frame may undergo a global brightness enhancement 245, or each locally-brightness-enhanced portion may undergo the local contrast enhancement operation 243.

The local contrast enhancement operation 243 generally operates to enhance the contrast of a portion of the current transformed image frame. Enhancing a portion of the current transformed image frame may include the processor 120 identifying that the brightness-enhanced portion has contrast falling outside of the contrast criterion and adjusting the contrast of the portion to satisfy the contrast criterion. For example, if the processor 120 determines that the desk portion has a contrast lower than a minimum contrast criterion, it may adjust (raise) the contrast of the desk portion until the contrast criterion is satisfied.

The global visual enhancement operation 244 generally operates to enhance visual quality of a transformed image frame as a whole. In this example, the global visual enhancement operation 244 includes a global brightness enhancement operation 245 and a global contrast enhancement operation 246. The global brightness enhancement operation 245 generally operates to enhance the brightness of the entirety of the transformed image frame. This may include the processor 120 determining that the transformed image frame as a whole has an average brightness outside of the brightness criterion and adjusting the brightness of the entirety of the transformed image frame to satisfy the brightness criterion. For example, if the processor 120 determines that the transformed image frame as a whole has a brightness lower than a minimum brightness criterion, it may adjust (raise) the brightness of the entire transformed image frame so as to satisfy the brightness criterion. The global contrast enhancement operation 246 generally operates to enhance the contrast of the entire transformed image. This may include the processor 120 identifying that the transformed image frame as a whole has an average contrast lower than a minimum contrast criterion and adjusting the contrast of the entire transformed image frame to satisfy the contrast criterion.

In some embodiments, a sequence of image frames of a scene may be captured and undergo one or more passthrough transformations to generate a corresponding sequence of transformed image frames. In these embodiments, the global visual enhancement operation 244 may use the information from previously-enhanced transformed image frames of the sequence during enhancement of subsequent image frames in order to reduce computations and complexities.

The consistency operation 247 generally operates to provide a consistency in the visual enhancements being made to a sequence of transformed image frames. In this example, the consistency operation 247 includes a brightness consistency operation 248 and a contrast consistency operation 249. The brightness consistency operation 248 generally operates to provide consistent brightness enhancements throughout a sequence of the transformed image frames. This may include the processor 120 monitoring the brightness adjustment made to each of the transformed image frames and correcting a brightness surge or drop between image frames in the sequence. For example, the processor 120 may balance brightness enhancement of each transformed image frame to provide a consistency in the brightness enhancements made throughout the sequence.

Similarly, the contrast consistency operation 249 generally operates to provide consistent contrast enhancement through the sequence of the transformed image frames. This may include the processor 120 monitoring the contrast adjustment made to each of the sequence of the transformed image frames and correcting a contrast surge or drop between the image frames in the sequence so as to ensure consistency of the contrast enhancement made throughout the sequence. For example, the processor 120 may balance contrast enhancement of each transformed image frame to provide a consistency in the contrast enhancements made throughout the sequence of the transformed image frames.

In some embodiments, the consistency operation 247 may include the processor 120 performing the local and global visual enhancements simultaneously for each of the transformed image frames. This can be done to help make the brightness and/or contrast consistent within each transformed image frame and between multiple transformed image frames in the sequence.

The color reconversion operation 250 generally operates to convert the YUV, YCbCr, HSV, or other format with a luminance channel to another image format, such as one that lacks a luminance channel (like RGB format). In some embodiments, the color reconversion operation 250 may convert image frames back into their original image format. In some cases, this may be done to make the visually enhanced transformed image frames compatible for display and to provide improved user experience. This may include the processor 120 determining RGB data or other image data for every pixel based on the YUV, YCbCr, or HSV image frame to generate a new RGB or other image frame. For example, if an enhanced luminance channel V is 0.7, the associated RGB value may be determined as R=V, G=0, and B=0. The § processor 120 can scale the RGB value and repeat this conversion for every pixel in the visually-enhanced transformed image frame, creating a new RGB or other image frame with enhanced brightness/contrast and the original colors.

The frame rendering operation 260 generally operates to create final image frames of the converted transformed image frames by the color reconversion operation 250. The frame rendering operation 260 can also render the final views for presentation to a user of the electronic device 101. For example, the frame rendering operation 260 may process the converted image frames and perform any additional refinements or modifications needed or desired, and the resulting images (referred to here as final image frames or final view frames) can represent the final views of the scene. For instance, a 3D-to-2D warping can be used to warp the final views of the scene into 2D images. The frame rendering operation 260 can also present the rendered images to the user. For example, the frame rendering operation 260 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

Although FIG. 2 illustrates one example of a process 200 for adaptive brightness and contrast enhancement for final view frames, various changes may be made to FIG. 2. For example, various components or functions in FIG. 2 may be combined, further subdivided, replicated, omitted, or rearranged and additional components or functions may be added according to particular needs. Also, the process 200 may be performed using any suitable number of image frames. In addition, while specific image formats (such as RGB, YUV, YCbCr, and HSV) are described above, any suitable image format(s) may be used here.

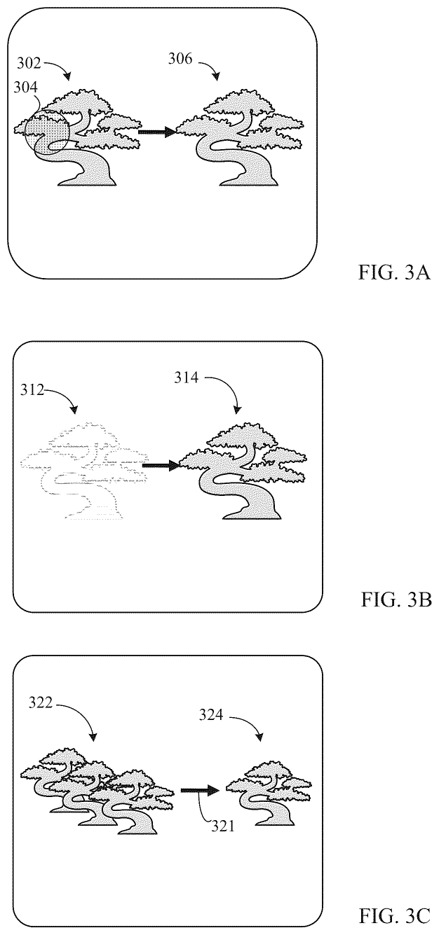

FIGS. 3A-3C illustrate example functions in the process 200 of FIG. 2 in accordance with this disclosure. As shown in FIG. 3A, one operation associated with the process 200 is a local visual enhancement operation 241. Here, a portion 304 of a transformed image frame 302 appears dark. Upon a determination that the brightness and/or contrast of the portion 304 is outside of a respective criterion, the local brightness and/or contrast enhancement operation(s) 242, 243 may be performed locally on the portion 304, while the rest of the transformed image remains intact. The visually-enhanced image frame 306 now includes a locally-enhanced portion 304 with enhanced visibility.

As shown in FIG. 3B, another operation that may be associated with the process 200 is a global visual enhancement operation 244. Here, the entire transformed image frame 312 appears dim and blurry. Upon a determination that the average brightness and/or contrast of the entire transformed image frame is outside of a respective criterion, the global brightness and/or contrast enhancement operation(s) 245, 246 may be performed globally, such as to the entirety of the transformed image frame. A visually-enhanced image frame 314 now appears brighter and clearer as a whole based on the globally-enhanced brightness and/or contrast.

As shown in FIG. 3C, yet another operation that may be associated with the process 200 is a consistency operation 247. In some cases, the local and global visual enhancement operations 241, 244 may be performed simultaneously to each transformed image frame of a sequence 322 of transformed image frames. The processor 120 may monitor the brightness and/or contrast adjustment(s) made to each of the transformed image frames and correct a brightness and/or contrast surge or drop between the transformed image frames in a sequence 322 so as to provide a consistency in brightness and/or contrast enhancements made throughout the sequence 322.

Although FIGS. 3A-3C illustrate example functions in the process 200 of FIG. 2, various changes may be made to FIGS. 3A-3C. For example, the contents of the various image frames and the various corrections made to the image frames are examples only and can easily vary depending on the circumstances.

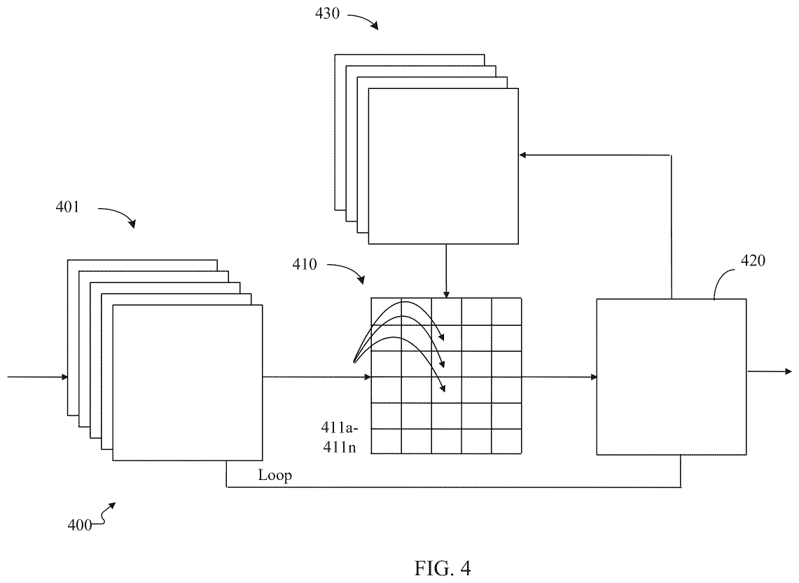

FIG. 4 illustrates an example visual enhancement operation technique 400 in accordance with this disclosure. The technique 400 may, for example, be used as part of the visual enhancement operation 240 of FIG. 2. For ease of explanation, the technique 400 shown in FIG. 4 is described as being implemented using the electronic device 101 in the network configuration 100 shown in FIG. 1, where the electronic device 101 may implement the process 200 shown in FIG. 2. However, the technique 400 may be implemented using any other suitable device(s) and in any other suitable system(s), and the technique 400 may be used to implement any other suitable process(es) designed in accordance with this disclosure.

As shown in FIG. 4, the visual enhancement operation technique 400 generally operates to perform visual enhancement using a sequence 401 of transformed image frames of a scene. In this example, the visual enhancement operation technique 400 includes a local visual enhancement operation 410, a global visual enhancement operation 420, and an enhancement information storage operation 430. The local visual enhancement operation 410 may be the same as or similar to the local visual enhancement operation 241 of FIG. 2 and generally operates to perform local brightness and/or contrast enhancement for each transformed image frame of the sequence 401. This may include the processor 120 creating different local enhancement approaches to process different portions 411a-n according to corresponding luminance statuses. For example, if the portion 411a is sufficiently bright (satisfies the brightness criterion), the processor 120 may not enhance the brightness of the portion 411a. If the portion 411a is not sufficiently bright (falls outside of the brightness criterion), the processor 120 enhances the brightness of the portion 411a. The local visual enhancement operation 410 may also or alternatively perform local contrast enhancement if needed. Different contrast enhancement approaches may be supported, such as adaptive gamma correction (adjusting the brightness of an image using a gamma curve), adaptive affine correction (adjusting an image by rotating, scaling, translating, or shearing using an affine matrix), and adaptive exposure adjustment (adjusting the amount of light captured by the imaging sensors 180).

The global visual enhancement operation 420 may be the same as or similar to the global visual enhancement operation 244 of FIG. 2 and generally operates to perform global brightness and/or contrast enhancement to the transformed image frames of the sequence 401. This may include the processor 120 developing different global enhancement approaches to process different image frames of the sequence 401 according to the luminance statuses of the image frames. In performing the global brightness and/or contrast enhancement, the processor 120 can utilize the enhanced image frame information, which in some cases may be stored in the memory 130.

The enhancement information storage operation 430 generally operates to store visual enhancement information made to the transformed image frames in the sequence 401. This may include the processor 120 storing data for each of the enhanced (locally and/or globally) image frames of the sequence 401. With this information, the global visual enhancement operation 420 can ensure that the brightnesses and contrasts between the image frames of the sequence 401 are consistent, such as by ensuring that there are no sudden surges or drops in the brightness and contrast between the image frames. In addition, this information may be used for visually-enhancing a current transformed image frame of the sequence 401 based on information associated with one or more previously-enhanced transformed image frames, thereby allowing the global enhancement operation 420 to reduce or avoid repetitive computations.

Upon performing the global visual enhancement operation 420 on the current transformed image frame, the visual enhancement operation technique 400 loops back to process the remaining transformed image frames of the sequence 401 and repeats the local and global visual enhancement operations 410, 420. The loop may be also repeated for the current image frame if it is determined that the enhanced current image frame does not satisfy the brightness criterion and/or contrast criterion. Note, however, that the operations of the process 200 may be pipelined so that processing of multiple image frames overlaps to some extent.

Although FIG. 4 illustrates one example of a visual enhancement operation technique 400, various changes may be made to FIG. 4. For example, various operations or functions in FIG. 4 may be combined, further subdivided, replicated, omitted, or rearranged and additional operations or functions may be added according to particular needs.

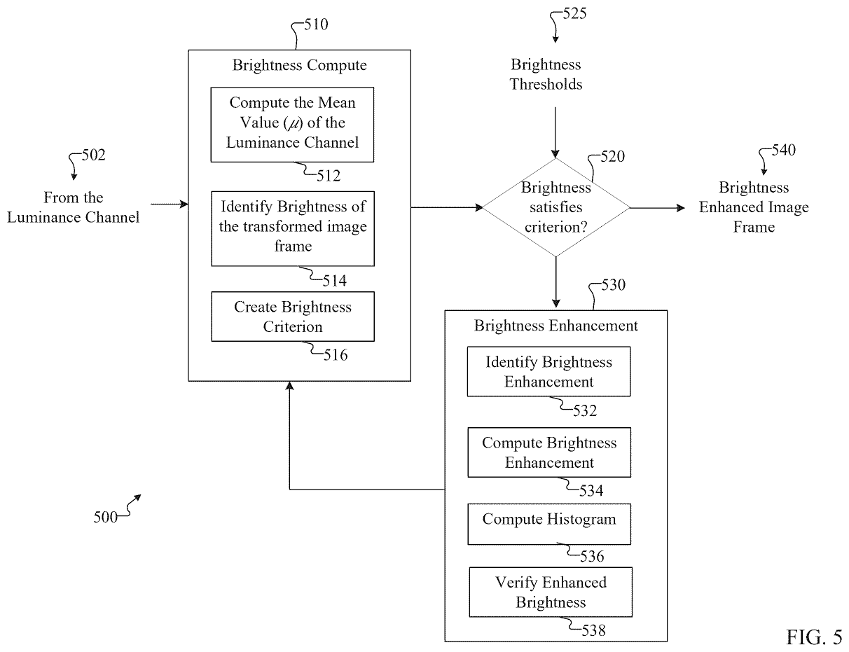

FIG. 5 illustrates an example brightness enhancement technique 500 in accordance with this disclosure. The technique 500 may, for example, be used as part of the visual enhancement operation 240 of FIG. 2. For ease of explanation, the technique 500 shown in FIG. 4 is described as being implemented using the electronic device 101 in the network configuration 100 shown in FIG. 1, where the electronic device 101 may implement the process 200 shown in FIG. 2. However, the technique 500 may be implemented using any other suitable device(s) and in any other suitable system(s), and the technique 500 may be used to implement any other suitable process(es) designed in accordance with this disclosure.

As shown in FIG. 5, the brightness enhancement technique 500 includes a brightness compute operation 510, a determination operation 520, and a brightness enhancement operation 530. The input to the technique 500 is a luminance component I(luminance) 502 of a current transformed image frame, and the output of the technique 500 is a brightness-enhanced luminance component I′(luminance) 540 of the transformed image frame.

The brightness compute operation 510 generally operates to determine a brightness of a luminance component 502 of a transformed image frame. In this example, the brightness compute operation 510 includes a mean compute operation 512, a brightness identification operation 514, and a brightness criterion creation operation 516. The mean compute operation 512 generally operates to determine the mean value μ of the luminance component I(luminance) 502, such as is shown in Equation (4). The brightness identification operation 514 generally operates to identify the brightness of the current transformed image frame. This may include the processor 120 identifying the computed mean value μ as the brightness B of the current transformed image frame, such as is shown in Equation (6).

The brightness criterion creation operation 516 generally operates to create the brightness criterion of the transformed image frame. This may include the processor 120 identifying brightness thresholds 525 for one or more similar or identical lightness environments as the current lightness environment and creating the brightness criterion based on the brightness thresholds. In some cases, the brightness thresholds may be predetermined, such as at manufacturing of the electronic device 101, and may include requirements for final view frames in respective lightness environments.

The determination operation 520 generally operates to determine if the brightness B of the current transformed image frame satisfies the brightness criterion. This may include the processor 120 checking the brightness criterion with the brightness thresholds 525. If the processor 120 determines that the brightness B of the current transformed image frame satisfies the brightness criterion, the brightness-enhanced luminance component 540 of the current transformed image frame is output for further processing or use (such as contrast enhancement or color reconversion).

If the processor 120 determines that the brightness B of the current transformed image frame does not satisfy the brightness criterion, the brightness enhancement operation 530 performs brightness enhancement on the current transformed image frame. In this example, the brightness enhancement operation 530 includes a brightness enhancement identification operation 532, a brightness enhancement compute operation 534, a histogram compute operation 536, and an enhanced brightness verification operation 538. The brightness enhancement identification operation 532 generally operates to identify a brightness enhancement algorithm based on the created brightness criterion and the corresponding thresholds (and possibly other factors). This may include the processor 120 identifying an appropriate enhancement algorithm, such as a gamma correction, a gain- and bias-based adjustment, or an exposure compensation, in accordance with the brightness criterion and the identified thresholds. Note, however, that any other or additional brightness enhancement approach(es) or any combination thereof can be used for brightness enhancement.

The brightness enhancement compute operation 534 generally operates to determine brightness enhancement with brightness verification using the identified enhancement algorithm. This may include the processor 120 applying a gamma correction to correct the brightness, such as by applying a non-linear transformation to the luminance component between the input and the mapped output. In some cases, this may be expressed as follows.

$${I}^{′} ( luminance ) = {( \frac{I ( luminance )}{255} )}^{γ} \times 255 \qquad ( 8 )$$

Here, I′(luminance) is the brightness enhanced luminance component, I(luminance) is the input luminance, and y is the gamma correction coefficient. When γ<1, the original dark region is brighter, and the associated histogram can be shifted to the right. When γ>1, the original bright region is darker, and the associated histogram can be shifted to the left.

As another example, the processor 120 may apply a gain- and bias-based brightness adjustment to adjust the brightness to the current transformed image frame. In some cases, this may be expressed as follows.

$${I}^{′} ( Luminance ) = α I ( luminance ) + β \qquad ( 9 )$$

Here, I′(luminance) is the enhanced luminance component, I(luminance) is the original luminance component, α is the gain parameter and β is the bias parameter. In this example, the parameter β can be used to control brightness.

As yet another example, the processor 120 may apply an exposure compensation, such as by modifying the exposure for the luminance component. In some cases, this may be expressed as follows.

$${I}^{′} ( Luminance ) = I ( luminance ) \times {2}^{η} \qquad ( 10 )$$

Here, I′(luminance) is the enhanced luminance component, I(luminance) is the original luminance component, and η is the exposure compensation coefficient.

The histogram compute operation 536 generally operates to determine a histogram of the luminance enhanced image. In some cases, this may be expressed as follows.

$${H}_{hist}^{′} = h ( {I}^{′} ( luminance ) , {N}_{bin} ) \qquad ( 11 )$$

Here, I′(luminance) is the enhanced luminance component of the color image, and N_{bin} is the number of the bins in building the image histogram.

The enhanced brightness verification operation 538 generally operates to verify the enhanced brightness. This may include the processor 120 verifying the enhanced brightness of the current transformed image with the histogram

$${H}_{hist}^{′} .$$

In some cases, the processor 120 may loop back to the brightness compute operation 510 until the determination operation 520 determines that the brightness of the current transformed image frame satisfies the brightness criterion. Upon such determination, the final brightness enhanced luminance component 540 of the current transformed image frame is obtained for a subsequent step.

Although FIG. 5 illustrates one example of a brightness enhancement technique 500, various changes may be made to FIG. 5. For example, various operations or functions in FIG. 5 may be combined, further subdivided, replicated, omitted, or rearranged and additional operations or functions may be added according to particular needs.

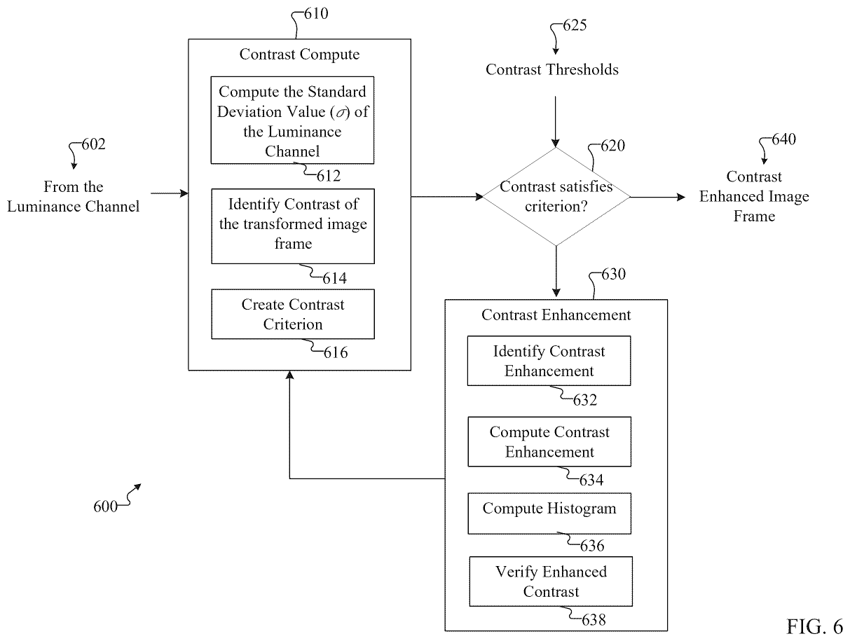

FIG. 6 illustrates an example contrast enhancement technique 600 in accordance with this disclosure. The technique 600 may, for example, be used as part of the visual enhancement operation 240 of FIG. 2. For ease of explanation, the technique 600 shown in FIG. 6 is described as being implemented using the electronic device 101 in the network configuration 100 shown in FIG. 1, where the electronic device 101 may implement the process 200 shown in FIG. 2. However, the technique 600 may be implemented using any other suitable device(s) and in any other suitable system(s), and the technique 600 may be used to implement any other suitable process(es) designed in accordance with this disclosure.

In this example, the contrast enhancement technique 600 includes a contrast compute operation 610, a determination operation 620, and a contrast enhancement operation 630. The input to the technique 600 is a luminance component I(luminance) 602 of a current transformed image frame, and the output of the technique 600 is a contrast-enhanced luminance component I′(luminance) 640 of the transformed image frame.

The contrast compute operation 610 generally operates to determine a contrast of a luminance component 602 of a current transformed image frame. In this example, the contrast compute operation 610 includes a standard deviation compute operation 612, a contrast identification operation 614, and a contrast criterion creation operation 616. The standard deviation compute operation 612 generally operates to determine the standard deviation value o of the luminance component I(luminance) of the current transformed image frame, such as is shown in Equation (4). The contrast identification operation 614 generally operates to identify the contrast of the current transformed image frame. This may include the processor 120 selecting the computed standard deviation value o as the brightness of the current transformed image, such as is shown in Equation (7).

The contrast criterion creation operation 616 generally operates to create the contrast criterion for the current transformed image frame. This may include the processor 120 identifying contrast thresholds and creating the brightness criterion based on the contrast thresholds. In some cases, the contrast thresholds may be predetermined, such as at manufacturing of the electronic device 101, and may include requirements for final view frames in respective lightness environments.

The determination operation 620 generally operates to determine if the contrast C of the current transformed image frame satisfies the contrast criterion. This may include the processor 120 checking the contrast criterion with contrast thresholds 625, such as those stored in a configuration file on the electronic device 101. If the processor 120 determines that the contrast C of the current transformed image frame satisfies the contrast criterion, the contrast enhanced luminance component 640 of the current transformed image frame is output for a subsequent step (such as contrast enhancement or color reconversion).

If the processor 120 determines that the contrast C of the current transformed image frame does not satisfy the contrast criterion, the contrast enhancement operations 630 performs contrast enhancement on the current transformed image frame. In this example, the contrast enhancement operation 630 includes a contrast enhancement identification operation 632, a contrast enhancement compute operation 634, a histogram compute operation 636, and an enhanced contrast verification operation 638. The contrast enhancement identification operation 632 generally operates to identify a contrast enhancement algorithm based on the created contrast criterion and the corresponding thresholds. This may include the processor 120 identifying an appropriate enhancement algorithm, such as a histogram equalization or a gain- and bias-based contrast adjustment, in accordance with the contrast criterion, the identified thresholds, and any requirements for the final view image frame for rendering. Note, however, that any other or additional contrast enhancement approach(es) or any combination thereof can be used for contrast enhancement.

The contrast enhancement compute operation 634 generally operates to perform contrast enhancement with contrast verification using the identified enhancement algorithm. This may include the processor 120 applying, for example, histogram equalization to improve image contrast. A histogram equalization algorithm can map one distribution represented by a given histogram to another distribution of wider and more-uniform luminance values, meaning the luminance values are spread out more over the whole transformed image frame. For example, suppose Hₕᵢₛₜ(luminance) is the histogram of the original luminance image computed with Equation (5). The processor 120 can compute the cumulative distribution

$${H}_{hist}^{′}$$

(luminance), such as in the following manner.

$${H}_{hist}^{′} ( i ) = {\sum }_{0 \leq j \leq i} {H}_{hist} ( j ) \qquad ( 12 )$$

A contrast-enhanced image may be determined using the cumulative distribution, such as in the following manner.

$${I}^{′} ( luminance ) = {H}_{hist}^{′} ( I ( luminance ) ) \qquad ( 13 )$$

Here, I′(luminance) is the contrast enhanced luminance image, and I(luminance) is the original luminance image.

The processor 120 may also apply a gain- and bias-based contrast adjustment. In some cases, this may be expressed as follows.

$${I}^{′} ( Luminance ) = α I ( luminance ) + β \qquad ( 14 )$$

Here, I′(luminance) is the enhanced luminance component, I(luminance) is the original luminance component, α is the gain parameter and β is the bias parameter. In this example, the parameter α can be used to control contrast.

The compute histogram operation 636 generally operates to determine a histogram of enhanced image frames. This may include the processor 120 determining a histogram of the luminance-enhanced image frame. In some cases, this may be expressed as follows.

$${H}_{hist}^{′} = h ( {I}^{′} ( luminance ) , {N}_{bin} ) \qquad ( 15 )$$

Here, I′(luminance) is the enhanced luminance component of the color image frame, and N_{bin} is the number of the bins in building the image histogram.

The enhanced contrast verification operation 638 generally operates to verify the enhanced contrast with the computed histogram

$${H}_{hist}^{′} .$$

In some cases, the processor 120 may loop back to the contrast compute operation 610 until the determination operation 620 determines that the contrast of the current transformed image frame satisfies the contrast criterion. Upon such determination, the final contrast enhanced luminance component 640 of the current transformed image frame is obtained.

Although FIG. 6 illustrates one example of a contrast enhancement technique 600, various changes may be made to FIG. 6. For example, various operations or functions in FIG. 6 may be combined, further subdivided, replicated, omitted, or rearranged and additional operations or functions may be added according to particular needs.

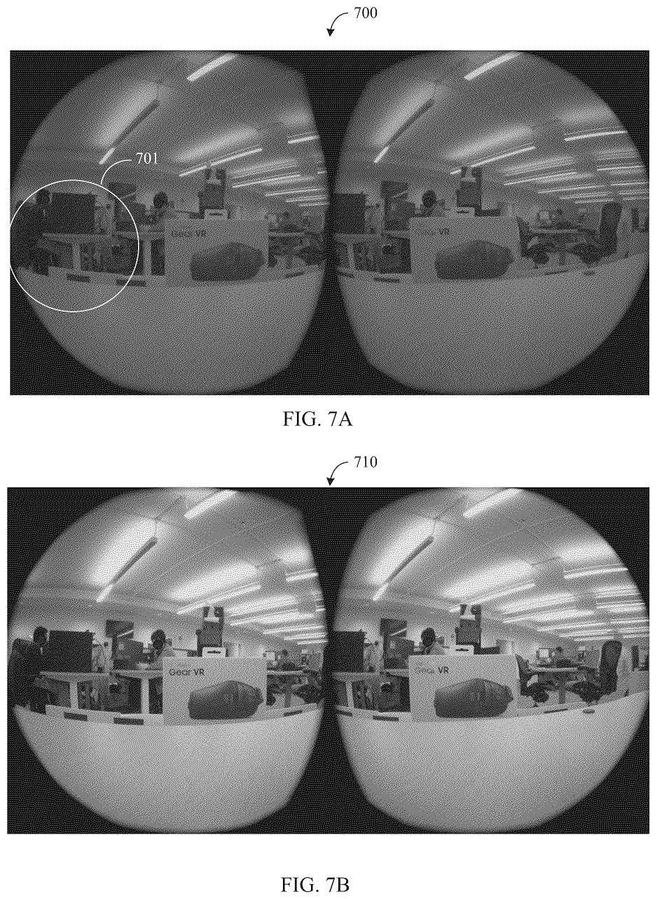

FIGS. 7A-7B illustrate example results obtainable using adaptive brightness and contrast enhancement in accordance with this disclosure. More specifically, FIG. 7A illustrates example output images 700 generated without using adaptive brightness and contrast enhancement. As can be seen here, the output images 700 appear to have low brightness and contrast as a whole and in part. That is, the entire stereo pair of images appears too dark, and a portion 701 of the left image includes objects that are difficult to distinguish from their surroundings. Among other things, this can cause discomfort to a user viewing the output images 700 or otherwise reduce the user's experience.

FIG. 7B illustrates an example stereo pair of output images 710 generated using the techniques described above. As can be seen here, the resulting images 710 provide much better results compared to the images 700. Among other reasons, this is because the electronic device 101 is able to perform adaptive brightness and contrast enhancement on-the-fly to generate visually enhanced images. This can result in significant improvements in the quality of the resulting output images, thereby improving the user's experience.

Although FIGS. 7A and 7B illustrate one example of results obtainable using adaptive brightness and contrast enhancement, various changes may be made to FIGS. 7A-7B. For example, FIGS. 7A-7B are merely meant to illustrate one example of a type of benefit that might be obtained using the techniques of this disclosure. The specific results that are obtained in any given situation can vary based on the circumstances and based on the specific implementation of the techniques described in this disclosure.

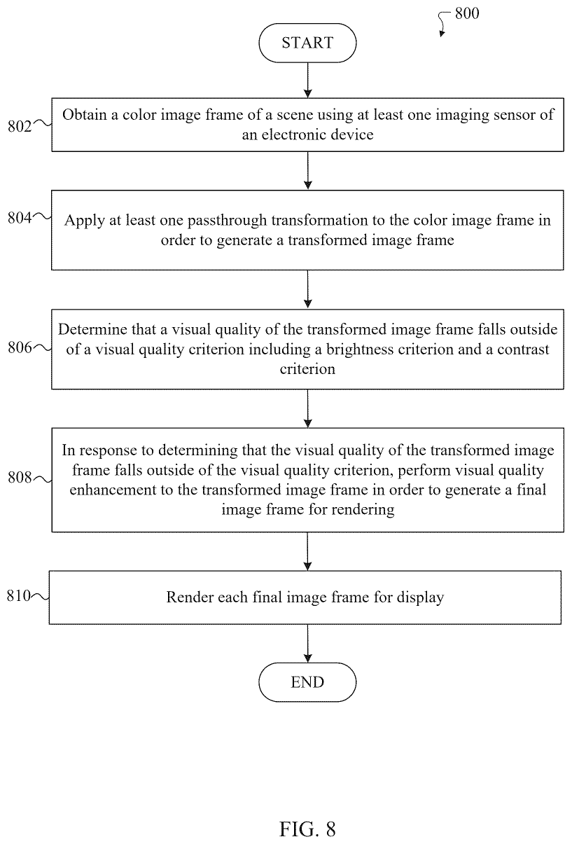

FIG. 8 illustrates an example method 800 for adaptive brightness and contrast enhancement in accordance with this disclosure. For case of explanation, the method 800 shown in FIG. 8 is described as being performed using the electronic device 101 in the network configuration 100 shown in FIG. 1, where the electronic device 101 may implement the process 200 shown in FIG. 2. However, the method 800 may be performed using any other suitable device(s) and in any other suitable system(s), and the method 800 may be implemented using any other suitable process(es) or architecture(s) designed in accordance with this disclosure.

As shown in FIG. 8, a color image frame of a scene is obtained at step 802. This may include, for example, the processor 120 of the electronic device 101 obtaining a color image frame captured using at least one imaging sensor 180 of the electronic device 101. At least one passthrough transformation is applied to the color image frame in order to generate a transformed image frame at step 804. This may include, for example, the processor 120 of the electronic device 101 performing the passthrough transformation operation 210 to apply one or more static or dynamic transformations to the image frame, such as any or all of the static or dynamic transformations described above.

A determination is made whether a visual quality of the transformed image frame falls outside of a visual quality criterion at step 806. This may include, for example, the processor 120 converting a color format of the transformed image frame to a format that includes a luminance channel. This may also include the processor 120 extracting a luminance component from the transformed image frame, determining brightness and contrast of the transformed image frame using the luminance component, and creating a brightness criterion and a contrast criterion based on the brightness and contrast of the transformed image frame and specified brightness and contrast thresholds. This may further include the processor 120 determining whether the transformed image frame has brightness falling outside of the brightness criterion and/or contrast falling outside of the contrast criterion. In some cases, the determined brightness can represent a mean value of the luminance component, and the determined contrast can represent a standard deviation value of the luminance component.

In response to the determination that the visual quality of the transformed image frame falls outside of the visual quality criterion, visual quality enhancement to the transformed image frame is performed in order to generate a final image frame for rendering at step 808. This may include, for example, the processor 120 of the electronic device 101 applying a local visual enhancement to one or more portions of the transformed image frame, where the one or more portions have a visual quality outside of the visual quality threshold. In some cases, applying the local visual enhancement may include the processor 120 identifying the one or more portions of the transformed image frame having the visual quality falling outside of the visual quality criterion, identifying one or more visual enhancement algorithms for the one or more portions of the transformed image, determining enhanced brightness and enhanced contrast for the one or more portions of the transformed image using the one or more visual enhancement algorithms, and verifying the enhanced brightness and the enhanced contrast using a histogram of the transformed image frame and one or more specified thresholds.

Performing the visual quality enhancement may also include applying a global visual enhancement to the transformed image frame. In some cases, applying the global visual enhancement may include the processor 120 of the electronic device 101 identifying one or more visual enhancement algorithms for the transformed image frame, determining enhanced brightness and enhanced contrast for the transformed image frame using the one or more visual enhancement algorithms, and verifying the enhanced brightness and the enhanced contrast using a histogram of the transformed image frame and one or more specified thresholds.

The one or more visual enhancement algorithms used here can include one or more brightness enhancement algorithms and/or one or more contrast enhancement algorithms. Also, the color image frame may represent one of a sequence of color image frames, and the passthrough transformation may be applied to each color image frame of the sequence to generate a corresponding sequence of transformed image frames. In those cases, performing the visual quality enhancement may include the processor 120 balancing brightness enhancement and contrast enhancement of each transformed image frame to provide consistency in the brightness enhancements and contrast enhancements throughout the sequence of transformed image frames.

The enhanced image frames may be used in any suitable manner. For example, each enhanced image frame may be used as a final image frame, and the final image frame may be rendered for display at step 810. This may include, for example, the processor 120 of the electronic device 101 rendering each final image frame for display on one or more display panels forming the display 160 of the electronic device 101.

Although FIG. 8 illustrates one example of a method 800 for adaptive brightness and contrast enhancement, various changes may be made to FIG. 8. For example, while shown as a series of steps, various steps in FIG. 8 may overlap, occur in parallel, occur in a different order, or occur any number of times (including zero times).

It should be noted that the functions shown in or described with respect to FIGS. 2 through 8 can be implemented in an electronic device 101, 102, 104, server 106, or other device(s) in any suitable manner. For example, in some embodiments, at least some of the functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 8 can be implemented or supported using dedicated hardware components. In general, the functions shown in or described with respect to FIGS. 2 through 8 can be performed using any suitable hardware or any suitable combination of hardware and software/firmware instructions. Also, the functions shown in or described with respect to FIGS. 2 through 8 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one imaging sensor of an electronic device, a color image frame of a scene;
applying, using at least one processing device of the electronic device, at least one passthrough transformation to the color image frame in order to generate a transformed image frame;
determining, using the at least one processing device, that a visual quality of the transformed image frame falls outside of a visual quality criterion including a brightness criterion and a contrast criterion; and
in response to determining that the visual quality of the transformed image frame falls outside of the visual quality criterion, performing, using the at least one processing device, visual quality enhancement to the transformed image frame in order to generate a final image frame for rendering.

2. The method of claim 1, wherein performing the visual quality enhancement comprises:
applying a local visual enhancement to one or more portions of the transformed image frame, the one or more portions having the visual quality outside of the visual quality threshold; and
applying a global visual enhancement to the transformed image frame.

3. The method of claim 2, wherein applying the local visual enhancement comprises:
identifying the one or more portions of the transformed image frame having the visual quality falling outside of the visual quality criterion;
identifying one or more visual enhancement algorithms for the one or more portions of the transformed image, the one or more visual enhancement algorithms including one or more brightness enhancement algorithms and one or more contrast enhancement algorithms;
determining enhanced brightness and enhanced contrast for the one or more portions of the transformed image using the one or more visual enhancement algorithms; and
verifying the enhanced brightness and the enhanced contrast using a histogram of the transformed image frame and one or more specified thresholds.

4. The method of claim 2, wherein applying the global visual enhancement comprises:
identifying one or more visual enhancement algorithms for the transformed image frame, the one or more visual enhancement algorithms including one or more brightness enhancement algorithms and one or more contrast enhancement algorithms;
determining enhanced brightness and enhanced contrast for the transformed image frame using the one or more visual enhancement algorithms; and
verifying the enhanced brightness and the enhanced contrast using a histogram of the transformed image frame and one or more specified thresholds.

5. The method of claim 1, wherein:
the color image frame is one of a sequence of color image frames;
the passthrough transformation is applied to each color image frame of the sequence to generate a corresponding sequence of transformed image frames; and
performing the visual quality enhancement comprises balancing brightness enhancement and contrast enhancement of each transformed image frame to provide consistency in the brightness enhancements and contrast enhancements throughout the sequence of transformed image frames.

6. The method of claim 1, wherein determining that the visual quality criterion falls outside of the visual quality criterion comprises:
converting a color format of the transformed image frame;
extracting a luminance component from the converted color format of the transformed image frame;
determining brightness and contrast of the transformed image frame using the luminance component;
creating the brightness criterion and the contrast criterion based on the brightness and contrast of the transformed image frame and specified brightness and contrast thresholds; and
determining that the transformed image frame has brightness falling outside of the brightness criterion and/or contrast falling outside of the contrast criterion.

7. The method of claim 6, wherein:
the determined brightness is a mean value of the luminance component; and
the determined contrast is a standard deviation value of the luminance component.

8. The method of claim 1, further comprising:
rendering, using the at least one processing device, the final image frame for display.

9. An apparatus comprising:
at least one imaging sensor configured to obtain color image frame of a scene; and
at least one processing device configured to:
apply at least one passthrough transformation to the color image frame in order to generate a transformed image frame;
determine that a visual quality of the transformed image frame falls outside of a visual quality criterion including a brightness criterion and a contrast criterion; and
in response to determining that the visual quality of the transformed image frame falls outside of the visual quality criterion, perform visual quality enhancement to the transformed image frame in order to generate a final image frame for rendering.

10. The apparatus of claim 9, wherein, to perform the visual quality enhancement, the at least one processing device is configured to:
apply a local visual enhancement to one or more portions of the transformed image frame, the one or more portions having the visual quality outside of the visual quality threshold; and
apply a global visual enhancement to the transformed image frame.

11. The apparatus of claim 10, wherein, to apply the local visual enhancement, the at least one processing device is configured to:
identify the one or more portions of the transformed image frame having the visual quality falling outside of the visual quality criterion;
identify one or more visual enhancement algorithms for the one or more portions of the transformed image, the one or more visual enhancement algorithms including one or more brightness enhancement algorithms and one or more contrast enhancement algorithms;
determine enhanced brightness and enhanced contrast for the one or more portions of the transformed image using the one or more visual enhancement algorithms; and
verify the enhanced brightness and the enhanced contrast using a histogram of the transformed image frame and one or more specified thresholds.

12. The apparatus of claim 10, wherein, to apply the global visual enhancement, the at least one processing device is configured to:
identify one or more visual enhancement algorithms for the transformed image frame, the one or more visual enhancement algorithms including one or more brightness enhancement algorithms and one or more contrast enhancement algorithms;
determine enhanced brightness and enhanced contrast for the transformed image frame using the one or more visual enhancement algorithms; and
verify the enhanced brightness and the enhanced contrast using a histogram of the transformed image frame and one or more specified thresholds.

13. The apparatus of claim 9, wherein:
the color image frame is one of a sequence of color image frames;
the passthrough transformation is applied to each color image frame of the sequence to generate a corresponding sequence of transformed image frames; and
to perform the visual quality enhancement, the at least one processing device is configured to balance brightness enhancement and contrast enhancement of each transformed image frame to provide consistency in the brightness enhancements and contrast enhancements throughout the sequence of transformed image frames.

14. The apparatus of claim 9, wherein, to determine that the visual quality criterion falls outside of the visual quality criterion, the at least one processing device is configured to:
convert a color format of the transformed image frame;
extract a luminance component from the converted color format of the transformed image frame;
determine brightness and contrast of the transformed image frame using the luminance component;
create the brightness criterion and the contrast criterion based on the brightness and contrast of the transformed image frame and specified brightness and contrast thresholds; and
determine that the transformed image frame has brightness falling outside of the brightness criterion and/or contrast falling outside of the contrast criterion.

15. A non-transitory machine readable medium containing instructions that when executed cause at least one processor of an electronic device to:
obtain color image frame of a scene using at least one imaging sensor;
apply at least one passthrough transformation to the color image frame in order to generate a transformed image frame;
determine that a visual quality of the transformed image frame falls outside of a visual quality criterion including a brightness criterion and a contrast criterion; and
in response to determining that the visual quality of the transformed image frame falls outside of the visual quality criterion, perform visual quality enhancement to the transformed image frame in order to generate a final image frame for rendering.

16. The non-transitory machine readable medium of claim 15, wherein the instructions that when executed cause the at least one processor to perform the visual quality enhancement comprise instructions that when executed cause the at least one processor to:
apply a local visual enhancement to one or more portions of the transformed image frame, the one or more portions having the visual quality outside of the visual quality threshold; and
apply a global visual enhancement to the transformed image frame.

17. The non-transitory machine readable medium of claim 16, wherein the instructions that when executed cause the at least one processor to apply the local visual enhancement comprise instructions that when executed cause the at least one processor to:
identify the one or more portions of the transformed image frame having the visual quality falling outside of the visual quality criterion;
identify one or more visual enhancement algorithms for the one or more portions of the transformed image, the one or more visual enhancement algorithms including one or more brightness enhancement algorithms and one or more contrast enhancement algorithms;
determine enhanced brightness and enhanced contrast for the one or more portions of the transformed image using the one or more visual enhancement algorithms; and
verify the enhanced brightness and the enhanced contrast using a histogram of the transformed image frame and one or more specified thresholds.

18. The non-transitory machine readable medium of claim 16, wherein the instructions that when executed cause the at least one processor to apply the global visual enhancement comprise instructions that when executed cause the at least one processor to:
identify one or more visual enhancement algorithms for the transformed image frame, the one or more visual enhancement algorithms including one or more brightness enhancement algorithms and one or more contrast enhancement algorithms;
determine enhanced brightness and enhanced contrast for the transformed image frame using the one or more visual enhancement algorithms; and
verify the enhanced brightness and the enhanced contrast using a histogram of the transformed image frame and one or more specified thresholds.

19. The non-transitory machine readable medium of claim 15, wherein:
the color image frame is one of a sequence of color image frames;
the passthrough transformation is applied to each color image frame of the sequence to generate a corresponding sequence of transformed image frames; and
the instructions that when executed cause the at least one processor to perform the visual quality enhancement comprise instructions that when executed cause the at least one processor to balance brightness enhancement and contrast enhancement of each transformed image frame to provide consistency in the brightness enhancements and contrast enhancements throughout the sequence of transformed image frames.

20. The non-transitory machine readable medium of claim 15, wherein the instructions that when executed cause the at least one processor to determine that the visual quality criterion falls outside of the visual quality criterion comprise instructions that when executed cause the at least one processor to:
convert a color format of the transformed image frame;
extract a luminance component from the converted color format of the transformed image frame;
determine brightness and contrast of the transformed image frame using the luminance component;
create the brightness criterion and the contrast criterion based on the brightness and contrast of the transformed image frame and specified brightness and contrast thresholds; and
determine that the transformed image frame has brightness falling outside of the brightness criterion and/or contrast falling outside of the contrast criterion.
